(19) United States
(12) Patent Application Publication
(10) Pub. No.: US 2007/0074040 A1
(43) Pub. Date: Mar. 29, 2007

(54) Online authorization using biometric and digital signature schemes

(75) Inventor: Shreekanth Lakshmeshwar, Espoo (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/238,340

(22) Filed: Sep. 29, 2005

(51) Int. Cl. H04L 9/00; H04K 1/00

(52) U.S. Cl. 713/186; 713/176; 713/178

(57) ABSTRACT

A method, system, mobile terminal and computer program product for authenticating a user's signature is provided. In general, the authentication scheme introduced combines the benefits of both biometric and digital signature schemes by projecting a sequence of predefined images onto a surface, enabling the user to sign, or otherwise write, across the projected images, capturing this signing process in the form, for example, of a video clip, applying the user's digital signature to the clip of his/her biometric signature, and then using the biometric and digital signatures to authenticate the user.

### FIELD OF THE INVENTION

Embodiments of the present invention relate to online authorization and authentication, and more particularly to an improved authentication scheme using a combination of biometric and digital signatures.

### BACKGROUND OF THE INVENTION

As the Internet has become more and more widely used, online authorization has become required in almost every aspect of communication. In the past, username and password methods were often used to provide such online authorization. Currently, digital certificate-based, as well as biometric-based, authentication schemes are also often used; thus resulting in some form of user signature being used throughout the Internet for authentication and authorization purposes.

Digital certificate-based authentication schemes typically rely on public key cryptography. In public key cryptography, each user has a pair of keys: a private key and a public key. The user distributes the public key freely, while maintaining the private key as a secret. When a user wants to send a message to a recipient and wants to prove that it was the user him/herself that sent it, the user will attach a digital signature to the message. The digital signature is generated using the user's private key and typically takes the form of a simple numeric value. On receipt, the recipient can verify that the message actually came from the user by running a verification algorithm on the message along with the signature and the user's public key. If they match, the recipient can be confident that the message came from the user, since the signing algorithm is designed so that it is very difficult to forge a signature to match a given message without knowing the user's private key, which should be secret.

One potential problem with digital signature schemes, however, is based on their reliance on digital key pairs, which are vulnerable to being lost and/or stolen. If one party loses its key, any other party that acquires it can use it as if they were the true owner. Keys are especially susceptible to being lost, since they are often stored on personal computers (PCs), which are prone to virus attacks, or on mobile devices or smart cards, which are prone to being stolen or lost.

Biometric-based authentication schemes, which measure and analyze human physiological characteristics, such as fingerprints, eye retinas and irises, voice patterns, facial patterns, and hand measurements, for authentication purposes, potentially solve this problem by eliminating the use of keys that could be used by parties other than the true owner. However, these schemes often have specific hardware requirements, which may cause their use to be more costly.

A need, therefore, exists for an improved method of online authorization that combines the benefits of both biometric and digital signature schemes.

### BRIEF SUMMARY OF THE INVENTION

Generally described, exemplary embodiments of the present invention provide an improvement over the known prior art by, among other things, providing a more secure method of authenticating a user that is based on both biometric-based signature schemes and digital-based signature schemes.

According to one aspect of the invention, a method of authenticating a signature of a user that is associated with data being transmitted by the user is provided. In one exemplary embodiment, the method includes: (1) projecting a sequence of predefined images onto a surface, the sequence comprising one or more individual predefined images; (2) capturing a clip of the user writing across the projected sequence of predefined images; and (3) transmitting a message comprising the clip and the data for authentication.

In one exemplary embodiment the sequence of predefined images includes one or more individual bar code images. In addition, projecting the sequence of predefined images onto a surface may, in one exemplary embodiment, involve projecting the one or more individual predefined images of the sequence one at a time at intervals of a predefined length of time.

The method of exemplary embodiments may further include: receiving a random number (RAND); generating a sequence of random numbers using the RAND received; and converting the sequence of random numbers into the sequence of predefined images projected onto the surface.

In one exemplary embodiment a digital signature of the user is applied to the clip and to the data, and the message transmitted for authentication thereby includes the digital signature of the user. Applying the digital signature of the user may involve using a private key associated with the user to encrypt a unique identifier also associated with the user, and attaching the encrypted unique identifier to the clip and to the data.

According to another aspect of the invention, a mobile terminal is provided that is capable of authenticating a signature of a user on data being transmitted by the user. In one exemplary embodiment, the mobile terminal includes: (1) a processor; (2) a projector in communication with the processor that is capable of projecting a sequence of predefined images onto a surface with the sequence comprising one or more individual predefined images; (3) a camera in communication with the processor that is capable of capturing a clip of the user writing across the projected sequence of predefined images; and (4) a memory in communication with the processor that stores an application executable by the processor, wherein the application is capable, upon execution, of transmitting a message comprising the clip and the data for authentication.

According to yet another aspect of the invention, a system for authenticating a signature of a user on data being transmitted by the user is provided. In one exemplary embodiment, the system includes a network authentication server (NAS) and a mobile terminal in communication with the NAS. The mobile terminal of one exemplary embodiment is capable of projecting a sequence of predefined images onto a surface, capturing a clip of the user writing across the projected sequence of predefined images, and transmitting a message comprising the clip and the data to the NAS. The NAS of one exemplary embodiment is, in turn, capable of receiving the message and authenticating the signature of the user based at least in part on the message received. The system of one exemplary embodiment may further include a database accessible by the NAS in which the NAS can store at least the clip received from the mobile terminal.

According to another aspect of the invention a computer program product is provided for authenticating a signature of a user that is associated with data being transmitted by the user. The computer program product comprises at least one computer-readable storage medium having computer-readable program code portions stored therein. In one exemplary embodiment these computer-readable program code portions may include: (1) a first executable portion for directing projection of a sequence of predefined images onto a surface with the sequence comprising one or more individual predefined images; (2) a second executable portion for directing capture of a clip of the user writing across the projected sequence of predefined images; and (3) a third executable portion for transmitting a message comprising the clip and the data for authentication.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a block diagram of one type of system that would benefit from exemplary embodiments of the present invention;

FIG. 2 is a schematic block diagram of an entity capable of operating as a mobile station, a network authentication server (NAS), or other communications device, in accordance with exemplary embodiments of the present invention;

FIG. 3 is a schematic block diagram of a mobile station capable of operating in accordance with an exemplary embodiment of the present invention;

FIG. 4 illustrates a sequence of steps that could be taken and signals that could be transmitted in order to authenticate a user's signature in accordance with an exemplary embodiment of the present invention; and

FIG. 5 illustrates a user writing across a projected sequence of bar code images in accordance with an exemplary embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Overview:

In general, exemplary embodiments of the present invention provide a user authentication scheme that combines the use of a user's digital signature with his or her actual biometric signature. In particular, according to exemplary embodiments of the present invention, a mobile terminal or station is capable of projecting a sequence of predefined images onto a surface, over which the user can sign or otherwise write. The sequence of predefined images are unique to the mobile station and are based on a sequence of random numbers generated from a single random number (RAND) provided by a network authentication server (NAS). The mobile station is further capable of capturing a clip, for example a video clip, of the user signing, or otherwise writing, over the projected images and applying the user's digital signature to the clip and to the data ultimately being transmitted. The NAS can use the digital and biometric signatures to authenticate the user and can further store the biometric signature for later use in the case of a dispute. The method, system, mobile terminal and computer program product of exemplary embodiments of the present invention, therefore, provide a more secure authentication scheme than is currently available.

Overall System and Mobile Station:

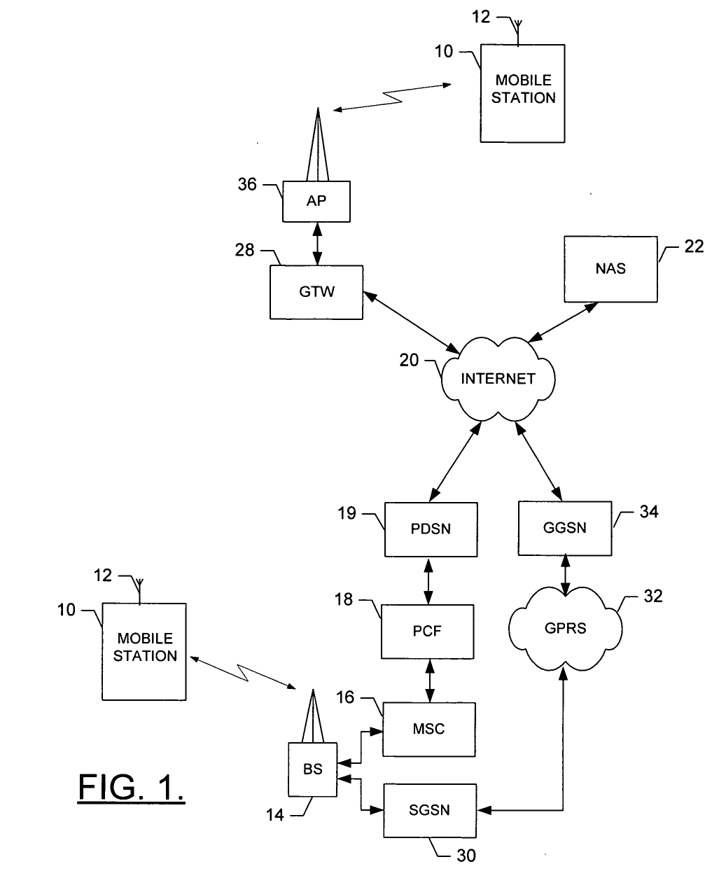

Referring to FIG. 1, an illustration of one type of system that would benefit from the present invention is provided. The system can include one or more mobile terminals or stations 10, each having an antenna 12 for transmitting signals to and for receiving signals from one or more base stations (BS's) 14. The base station is a part of one or more cellular or mobile networks that each includes elements required to operate the network, such as one or more mobile switching centers (MSC) 16. As well known to those skilled in the art, the mobile network may also be referred to as a Base Station/MSC/Interworking function (BMI). In operation, the MSC is capable of routing calls, data or the like to and from mobile stations when those mobile stations are making and receiving calls, data or the like. The MSC can also provide a connection to landline trunks when mobile stations are involved in a call.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a Packet Control Function (PCF) 18, and the PCF is coupled to a Packet Data Serving Node (PDSN) 19, which is in turn coupled to a WAN, such as the Internet 20. In turn, devices such as processing elements (e.g., personal computers, server computers or the like) can be coupled to the mobile station 10 via the Internet. For example, the processing elements can include one or more processing elements associated with a network authentication server (NAS) 22, which may be any corresponding node having an IP address which allows the mobile station 10 to communicate with it. As will be appreciated, the processing elements can comprise any of a number of processing devices, systems or the like capable of operating in accordance with embodiments of the present invention.

The BS 14 can also be coupled to a signaling GPRS (General Packet Radio Service) support node (SGSN) 30. As known to those skilled in the art, the SGSN is typically capable of performing functions similar to the MSC 16 for packet switched services. The SGSN, like the MSC, can be coupled to a data network, such as the Internet 20. The SGSN can be directly coupled to the data network. In a more typical embodiment, however, the SGSN is coupled to a packet-switched core network, such as a GPRS core network 32. The packet-switched core network is then coupled to another GTW, such as a GTW GPRS support node (GGSN) 34, and the GGSN is coupled to the Internet.

Although not every element of every possible network is shown and described herein, it should be appreciated that the mobile station 10 may be coupled to one or more of any of a number of different networks. In this regard, mobile network(s) can be capable of supporting communication in accordance with any one or more of a number of first-generation (1G), second-generation (2G), 2.5G and/or third-generation (3G) mobile communication protocols or the like. More particularly, one or more mobile stations may be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

One or more mobile stations 10 (as well as one or more processing elements, although not shown as such in FIG. 1) can further be coupled to one or more wireless access points (APs) 36. The AP's can be configured to communicate with the mobile station in accordance with techniques such as, for example, radio frequency (RF), Bluetooth (BT), infrared (IrDA) or any of a number of different wireless networking techniques, including WLAN techniques. The APs may be coupled to the Internet 20. Like with the MSC 16, the AP's can be directly coupled to the Internet. In one embodiment, however, the APs are indirectly coupled to the Internet via a GTW 28. As will be appreciated, by directly or indirectly connecting the mobile stations and the processing elements (e.g., NAS 22) and/or any of a number of other devices to the Internet, whether via the AP's or the mobile network(s), the mobile stations and processing elements can communicate with one another to thereby carry out various functions of the respective entities, such as to transmit and/or receive data, content or the like. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 1, in addition to or in lieu of coupling the mobile stations 10 to the NAS 22 across the Internet 20, one or more such entities may be directly coupled to one another. As such, one or more network entities may communicate with one another in accordance with, for example, RF, BT, IrDA or any of a number of different wireline or wireless communication techniques, including LAN and/or WLAN techniques. Further, the mobile station 10 and NAS 22 can be coupled to one or more electronic devices, such as printers, digital projectors and/or other multimedia capturing, producing and/or storing devices (e.g., other terminals).

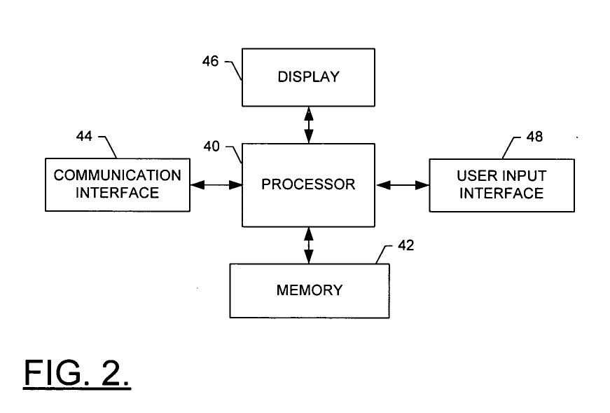

Referring now to FIG. 2, a block diagram of an entity capable of operating as a mobile station 10 and/or network authentication server (NAS) 22 is shown in accordance with one embodiment of the present invention. The entity capable of operating as a mobile station and/or NAS includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. As shown, the entity capable of operating as a mobile station 10 and/or NAS 22 can generally include means, such as a processor 40 connected to a memory 42, for performing or controlling the various functions of the entity. The memory can comprise volatile and/or non-volatile memory, and typically stores content, data or the like. For example, the memory typically stores content transmitted from, and/or received by, the entity. Also for example, the memory typically stores software applications, instructions or the like for the processor to perform steps associated with operation of the entity in accordance with embodiments of the present invention.

In addition to the memory 42, the processor 40 can also be connected to at least one interface or other means for displaying, transmitting and/or receiving data, content or the like. In this regard, the interface(s) can include at least one communication interface 44 or other means for transmitting and/or receiving data, content or the like, as well as at least one user interface that can include a display 46 and/or a user input interface 48. The user input interface, in turn, can comprise any of a number of devices allowing the entity to receive data from a user, such as a keypad, a touch display, a joystick or other input device.

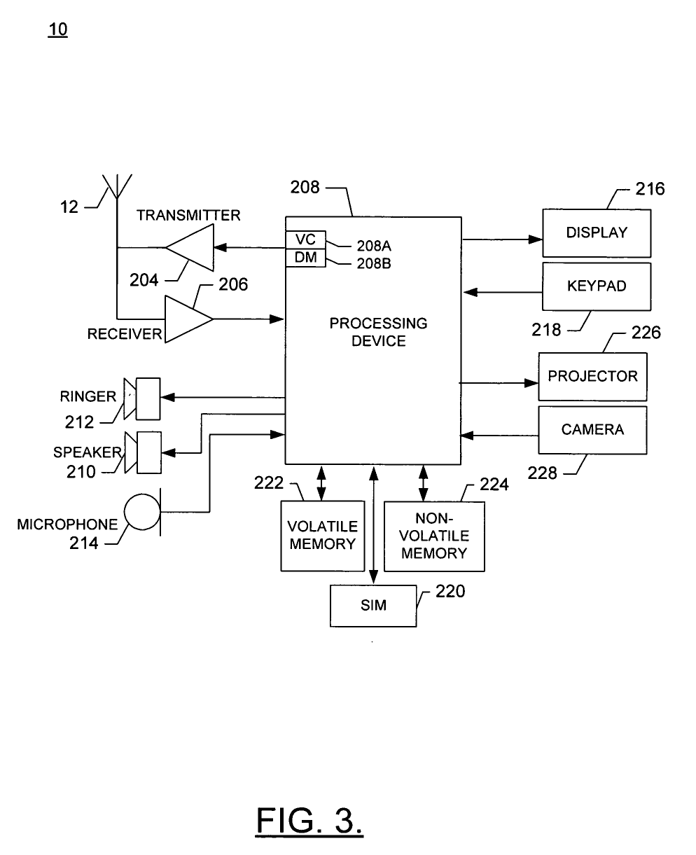

Reference is now made to FIG. 3, which illustrates one type of mobile station 10 that would benefit from embodiments of the present invention. It should be understood, however, that the mobile station illustrated and hereinafter described is merely illustrative of one type of mobile station that would benefit from the present invention and, therefore, should not be taken to limit the scope of the present invention. While several embodiments of the mobile station are illustrated and will be hereinafter described for purposes of example, other types of mobile stations, such as personal digital assistants (PDAs), pagers, laptop computers and other types of electronic systems including both mobile, wireless devices and fixed, wireline devices, can readily employ embodiments of the present invention.

The mobile station includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 3, in addition to an antenna 12, the mobile station 10 includes a transmitter 204, a receiver 206, and means, such as a processing device 208, e.g., a processor, controller or the like, that provides signals to and receives signals from the transmitter 204 and receiver 206, respectively. These signals include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5G and/or third-generation (3G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processing device 208, such as a processor, controller or other computing device, includes the circuitry required for implementing the video, audio, and logic functions of the mobile station and is capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 208 thus also includes the functionality to convolutionally encode and interleave message and data prior to modulation and transmission. The processing device can additionally include an internal voice coder (VC) 208A, and may include an internal data modem (DM) 208B. Further, the processing device 208 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means such as a user interface including, for example, a conventional earphone or speaker 210, a ringer 212, a microphone 214, a display 216, all of which are coupled to the controller 208. The user input interface, which allows the mobile device to receive data, can comprise any of a number of devices allowing the mobile device to receive data, such as a keypad 218, a touch display (not shown), a microphone 214, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 220, a removable user identity module (R-UIM) (not shown), or the like, which typically stores information elements related to a mobile subscriber. In addition to the SIM, the mobile device can include other memory. In this regard, the mobile station can include volatile memory 222, as well as other non-volatile memory 224, which can be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application and other computer programs. For example, in one embodiment of the present invention, the memory may store computer program code for directing the projection of a sequence of predefined images onto a surface, directing the capture of a user operating the mobile station 10 writing across the projected sequence, and transmitting a message including the captured clip and data to be authenticated to, for example, the NAS 22 for authentication. To that end, the mobile station 10 may further include means, such as a projector 226, for projecting the sequence of predefined images, and means, such as a camera 228, for capturing the clip of the user writing across the projected sequence.

The system, method, mobile terminal or station and computer program product of exemplary embodiments of the present invention are primarily described in conjunction with mobile communications applications. It should be understood, however, that the system, method, mobile station and computer program product of embodiments of the present invention can be utilized in conjunction with a variety of other applications, both in the mobile communications industries and outside of the mobile communications industries. For example, the system, method, mobile station and computer program product of exemplary embodiments of the present invention can be utilized in conjunction with wireline and/or wireless network (e.g., Internet) applications.

Online Authorization Using Biometric and Digital Signature Schemes:

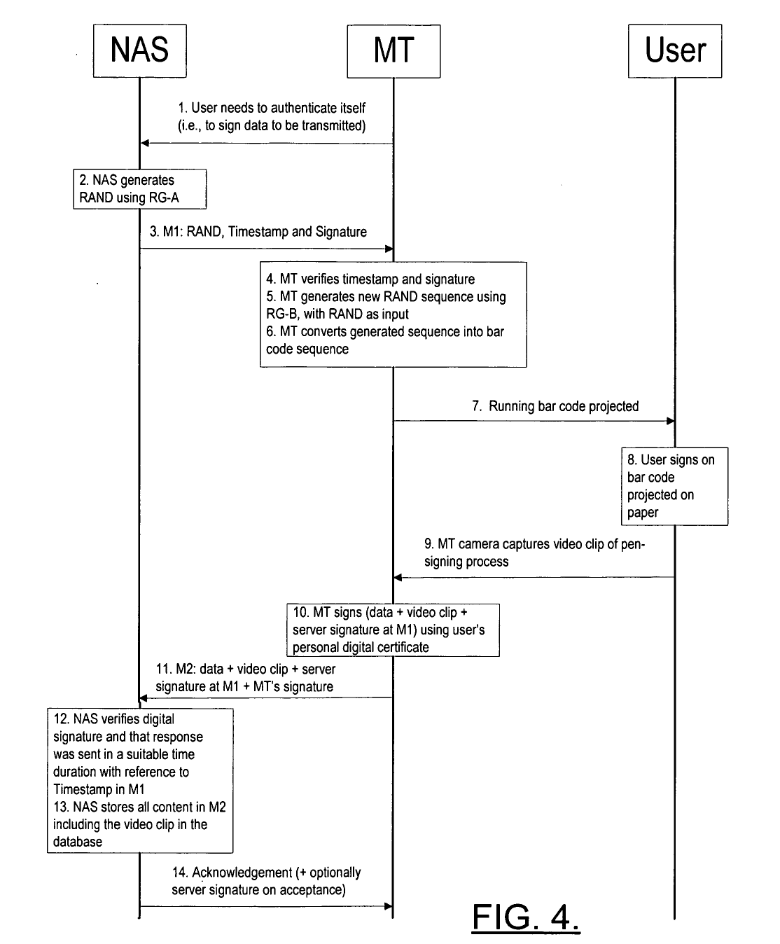

Reference is now made to FIG. 4, which illustrates a method of authenticating a user's signature that is associated with data being transmitted by the user in accordance with one exemplary embodiment of the present invention. As shown, the method begins when a user that is operating a mobile device or terminal (MT) needs to authenticate itself to an intended recipient of data the user wishes to transmit. In other words, the user needs to sign data that he or she is transmitting to another party. The MT will initiate authentication by first contacting a Network Authentication Server (NAS) (Step 1). The NAS may be operated by the party actually running the server-side authentication, or, alternatively, by some third party that provides authentication functionality.

In response to being contacted, the NAS will generate a random number (RAND) using a random number generation algorithm (RG-A) and transmit the RAND, along with a timestamp and a server signature on the RAND and timestamp, in a message (M1) to the MT (Steps 2 and 3, respectively). The server signature is a digital signature that consists of a unique identifier associated with the NAS that is encrypted using the NAS's private key. The MT can use the NAS's public key to decrypt the unique identifier in order to verify that M1 was transmitted by the NAS.

Upon receiving M1, in Step 4 the MT verifies the timestamp and the server signature. The MT then generates a new sequence of random numbers, in Step 5, by feeding the RAND received from the NAS into a random number generator (RG-B). RG-B and RG-A are both cryptographically strong and may in fact be the same random number generator.

In Step 6 the MT converts each random number of the generated sequence into a predefined image and, in Step 7, projects each predefined image of the sequence onto a surface (e.g., a wall or a piece of paper). Each predefined image (i.e., each random number in the sequence) is projected in sequence at a particular interval (T), which is defined as a system parameter. In one exemplary embodiment the sequence of predefined images may be a sequence of bar code images derived from the sequence of random numbers. As will be appreciated by those of ordinary skill in the art, however, embodiments of the invention are not limited to bar code images and, in contrast, could involve the projecting of any predefined image that is capable of being derived from the sequence of random numbers generated by the MT based on RAND.

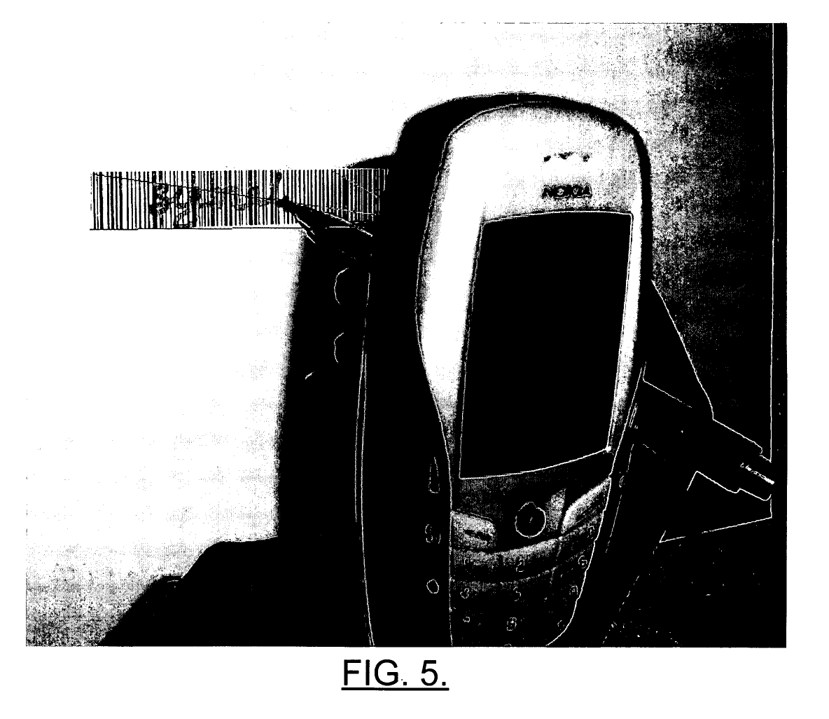

Once the images are projected, the user is then able to write across (e.g., sign on top of) the changing projected predefined (e.g., bar code) images (Step 8). FIG. 5 provides an illustration of an exemplary projection and writing process. The number of times the predefined images change throughout the writing process depends on the length of time taken by the user to sign or write across the projected sequence and the value assigned to T. Advantageously, T is defined such that the projected sequence changes at least once and, more commonly, two or more times during a typical writing sequence. This writing process is captured, in Step 9, as a clip, such as for example a video clip, using an integrated camera in the mobile terminal.

Next, the MT uses the user's personal digital certificate to sign (i) the data the user wishes to transmit; (ii) the clip capturing the signature process; and (iii) the server signature included in M1 (Step 10). In other words, as discussed above, the MT will use its private key to encrypt a unique identifier associated with the user. The resulting encrypted unique identifier acts as a digital signature, which will typically take the form of a simple numeric value and that can be attached to the data, clip and server signature prior to transmission.

The MT then transmits, in message M2, the data, clip, server signature included in M1, and digital signature to the NAS, in Step 11. Upon receipt, the NAS verifies the digital signature, for example using the MT's public key, (Step 12), and stores all of the content of M2, including the clip, in a database (Step 13). In particular, the NAS uses the reference found in M2 to check that within a certain time period the response was made by the MT to the M1 the NAS previously sent. That is, the NAS verifies this using the timestamp sent in M1. This proves to the NAS that the signature was made in time. In one exemplary embodiment, the MT may also provide its own timestamp indicating when the signature was made in M2. This would be beneficial where additional proof is needed for a later purpose.

The NAS may also verify the clip (e.g., the video, or biometric, signature) and/or that the predefined images generated in the clip are in accordance with the RAND originally sent by the NAS in M1. In any event, the clip of the user signing, or otherwise writing, across the projected predefined images that is now stored in a database accessible to the NAS can be used in the future in the instance where there is a dispute over whether the user him/herself actually applied the digital signature (since the private key may have been stolen and/or lost) and transmitted the data. Exemplary embodiments, therefore, provide additional security to the traditional digital-certificate based authentication schemes while not requiring the additional hardware typically required with biometric-based authentication schemes.

Finally, in Step 14 of FIG. 4, the NAS may send an acknowledgement to the MT optionally including the server signature on acceptance.

By changing the bar code image projected by the MT throughout the signature process based on the RAND sent by the NAS in M1, and by including a timestamp in M1, the system of exemplary embodiments of the present invention guarantees that the signing process actually occurred at that time and by that user. By also adding the user's digital signature, exemplary embodiments of the present invention further combine cryptography to the video clip and the data being transmitted. Exemplary embodiments of the present invention, therefore, add additional security while not changing the current digital certificate-based verification process.

Conclusion:

As described above and as will be appreciated by one skilled in the art, embodiments of the present invention may be configured as a system, method, mobile terminal device or other apparatus. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. For example, while the above-described embodiments project a sequence of numbers, such as in barcode form, the sequence of predefined images need not be numerical but may be any predefined sequence known to the NAS. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of authenticating a signature of a user that is associated with data being transmitted by the user, said method comprising:
projecting a sequence of predefined images onto a surface, the sequence comprising one or more individual predefined images;
capturing a clip of the user writing across the projected sequence of predefined images; and
transmitting a message comprising the clip and the data for authentication.

2. The method of claim 1, wherein the one or more individual predefined images comprise one or more individual bar code images.

3. The method of claim 1 further comprising:
receiving a random number (RAND);
generating a sequence of random numbers using the RAND received; and
converting the sequence of random numbers into the sequence of predefined images projected onto the surface.

4. The method of claim 3, wherein projecting the sequence of predefined images onto the surface comprises projecting the one or more individual predefined images of the sequence one at a time at intervals of a predetermined length of time.

5. The method of claim 3 further comprising:
applying a digital signature of the user to the clip and to the data, wherein the message transmitted for authentication further comprises the digital signature of the user.

6. The method of claim 5, wherein applying the digital signature of the user to the clip and to the data comprises:
using a private key associated with the user to encrypt a unique identifier also associated with the user; and
attaching the encrypted unique identifier to the clip and to the data.

7. The method of claim 3 further comprising:
receiving a timestamp, wherein a digital signature of a source of the timestamp is applied to the RAND and the timestamp; and
verifying the timestamp and the digital signature of the source of the timestamp.

8. The method of claim 7 further comprising:
applying a digital signature of the user to the clip, the data and the digital signature of the source of the timestamp, wherein the message transmitted for authentication further comprises the digital signature of the user.

9. The method of claim 1 further comprising:
receiving an acknowledgment that the signature of the user has been authenticated.

10. The method of claim 1, wherein the clip comprises a video clip.

11. A mobile terminal capable of authenticating a signature of a user that is associated with data being transmitted by the user, said mobile terminal comprising:
a processor;
a projector in communication with the processor that is capable of projecting a sequence of predefined images onto a surface, the sequence comprising one or more individual predefined images;
a camera in communication with the processor that is capable of capturing a clip of the user writing across the projected sequence of predefined images; and
a memory in communication with the processor that stores an application executable by the processor, wherein the application is capable, upon execution, of transmitting a message comprising the clip and the data for authentication.

12. The mobile terminal of claim 11, wherein the one or more individual predefined images comprise one or more individual bar code images.

13. The mobile terminal of claim 11, wherein the application is further capable, upon execution, of receiving a random number (RAND), generating a sequence of random numbers using the RAND received, and converting the sequence of random numbers into the sequence of predefined images projected onto the surface.

14. The mobile terminal of claim 13, wherein projecting the sequence of predefined images onto the surface comprises projecting the one or more individual predefined images of the sequence one at a time at intervals of a predetermined length of time.

15. The mobile terminal of claim 13, wherein the application is further capable, upon execution, of applying a digital signature of the user to the clip and to the data, wherein the message transmitted for authentication further comprises the digital signature of the user.

16. The mobile terminal of claim 15, wherein applying the digital signature of the user to the clip and to the data comprises using a private key associated with the user to encrypt a unique identifier also associated with the user, and attaching the encrypted unique identifier to the clip and to the data.

17. The mobile terminal of claim 13, wherein the application is further capable, upon execution, of receiving a timestamp, wherein a digital signature of a source of the timestamp is applied to the RAND and the timestamp, and of verifying the timestamp and the NAS signature.

18. The mobile terminal of claim 17, wherein the application is further capable, upon execution, of applying a digital signature of the user to the clip, the data and the digital signature of the source of the timestamp, and wherein the message transmitted for authentication further comprises the digital signature of the user.

19. The mobile terminal of claim 11, wherein the application is further capable, upon execution, of receiving an acknowledgement that the signature of the user has been authenticated.

20. The mobile terminal of claim 11, wherein the clip comprises a video clip.

21. A system for authenticating a signature of a user that is associated with data being transmitted by the user, said system comprising:
a network authentication server (NAS); and
a mobile terminal in communication with the NAS, the mobile terminal capable of projecting a sequence of predefined images onto a surface, capturing a clip of the user writing across the projected sequence of predefined images, and transmitting a message comprising the clip and the data to the NAS, wherein the NAS is capable of receiving the message and of authenticating the signature of the user based at least in part on the message received.

22. The system of claim 21, wherein the sequence of predefined images comprises a sequence of bar code images.

23. The system of claim 21 further comprising:
a database accessible by the NAS, wherein the NAS stores at least the clip received from the mobile terminal in the database.

24. The system of claim 23, wherein the NAS is further capable of generating a random number (RAND) and of transmitting the RAND to the mobile terminal.

25. The system of claim 24, wherein the mobile terminal is further capable of receiving the RAND, of generating a sequence of random numbers using the RAND received, and of converting the sequence of random numbers into the sequence of predefined images projected onto the surface.

26. The system of claim 25, wherein the mobile terminal is further capable of applying a digital signature of the user to the clip and to the data, wherein the message transmitted to the NAS further comprises the digital signature of the user.

27. The system of claim 26, wherein applying a digital signature of the user comprises:
using a private key associated with the user to encrypt a unique identifier also associated with the user; and
attaching the encrypted unique identifier to the clip and to the data.

28. The system of claim 25, wherein the NAS is further capable of transmitting a timestamp with the RAND to the mobile terminal, and of applying a NAS signature to the timestamp and the RAND prior to transmission.

29. The system of claim 28, wherein the mobile terminal is further capable of receiving the timestamp and the NAS signature from the NAS, and of verifying the timestamp and the NAS signature received.

30. The system of claim 29, wherein the mobile terminal is further capable of applying a digital signature of the user to the clip, the data and the NAS signature, and wherein the message transmitted to the NAS further comprises the digital signature of the user.

31. The system of claim 30, wherein the NAS stores in the database, along with the clip received from the mobile terminal, the digital signature of the user, the NAS signature, and the timestamp.

32. The system of claim 21, wherein the NAS is further capable of generating and transmitting to the mobile terminal an acknowledgement indicating that the signature of the user has been authenticated.

33. A computer program product for authenticating a signature of a user that is associated with data being transmitted by the user, wherein the computer program product comprises at least one computer-readable storage medium having computer-readable program code portions stored therein, the computer-readable program portions comprising:
a first executable portion for directing projection of a sequence of predefined images onto a surface, the sequence comprising one or more individual predefined images;
a second executable portion for directing capture of a clip of the user writing across the projected sequence of predefined images; and
a third executable potion for transmitting a message comprising the clip and the data for authentication.

34. The computer program product of claim 33, wherein the one or more individual predefined images comprise one or more individual bar code images.

35. The computer program product of claim 33 further comprising:
a fourth executable portion for receiving a random number (RAND);
a fifth executable portion for generating a sequence of random numbers using the RAND received; and
a sixth executable portion for converting the sequence of random numbers into the sequence of predefined images projected onto the surface.

36. The computer program product of claim 35, wherein directing projection of the sequence of predefined images onto the surface comprises directing projection of the one or more individual predefined images of the sequence one at a time at intervals of a predetermined length of time.

37. The computer program product of claim 35 further comprising:
a seventh executable portion for applying a digital signature of the user to the clip and to the data, wherein the message transmitted for authentication further comprises the digital signature of the user.

38. The computer program product of claim 37, wherein applying a digital signature of the user to the clip and to the data comprises:
using a private key associated with the user to encrypt a unique identifier also associated with the user; and
attaching the encrypted unique identifier to the clip and to the data.

39. The computer program product of claim 35 further comprising:
a seventh executable portion for receiving a timestamp, wherein a digital signature of a source of the timestamp is applied to the RAND and the timestamp; and
an eighth executable portion for verifying the timestamp and the digital signature of the source of the timestamp.

40. The computer program product of claim 39 further comprising:
a ninth executable portion for applying a digital signature of the user to the clip, the data and the digital signature of the source of the timestamp, wherein the message transmitted for authentication further comprises the digital signature of the user.

41. The computer program product of claim 33 further comprising:
a fourth executable portion for receiving an acknowledgement that the signature of the user has been authenticated.

42. The computer program product of claim 33, wherein the clip comprises a video clip.
